(19) United States
(12) Patent Application Publication
(10) Pub. No.: US 2023/0018368 A1
(43) Pub. Date: Jan. 19, 2023

(54) METHOD FOR IMPROVING DISPLAY OF COMPONENTS OR TYPES OF COMPONENTS WITHIN SURVEILLANCE VIDEOS, ELECTRONIC DEVICE EMPLOYING METHOD, AND COMPUTER READABLE STORAGE MEDIUM

(71) Applicant: Fulian Precision Electronics (Tianjin) Co., LTD, Tianjin (CN)

(72) Inventors: JHIH-JHONG LIN, New Taipei (TW); CHUN-NAN YU, New Taipei (TW); GUAN-RU CHEN, New Taipei (TW)

(21) Appl. No.: 17/536,299

(22) Filed: Nov. 29, 2021

(30) Foreign Application Priority Data
Jul. 13, 2021 (CN) 202110792066.9

(51) Int. Cl. G06V 20/52; H04N 5/232; H04N 5/247

(52) U.S. Cl. CPC G06V 20/52; H04N 5/23206; H04N 5/247; H04N 5/232939; H04N 5/23218

(57) ABSTRACT

A method for improving manner of display of surveillance video to extract components or types of components for independent display from the video. The displayable components are divided into at least one subject. A repeating displayed list is created corresponding to the at least one component or type of component. The videos corresponding thereto can be displayed in turn based on the display list in response to a play instruction from user. An electronic device and a computer readable storage medium applying the method are also provided.

### FIELD

The subject matter herein generally relates to surveillance videos display, specifically to method for improving manner of display of surveillance videos, an electronic device, and a computer readable storage medium employing the method.

### BACKGROUND

The image feeds from many image-capturing devices employed on surveillance are displayed in one frame. When the number of image-captures is many, it is hard to find target components of same type in the multi-location surveillance video.

Thus, there is room for improvement in the art.

### BRIEF DESCRIPTION OF THE DRAWINGS

Implementations of the present disclosure will now be described, by way of example only, with reference to the attached figures.

FIG. 1 is a diagram illustrating an embodiment of an electronic device according to the present disclosure.

FIG. 2 is a flowchart illustrating an embodiment of a method for improving manner of display of monitoring videos according to the present disclosure.

FIG. 3 is a diagram illustrating an embodiment of a monitoring interface displaying air conditioning as the displayed components according to the present disclosure.

FIG. 4 is a diagram illustrating an embodiment of a monitor interface displaying labels of air conditioning channel temperatures as the displayed components of according to the present disclosure.

### DETAILED DESCRIPTION

The present disclosure is described with reference to accompanying drawings and the embodiments. It will be understood that the specific embodiments described herein are merely part of all embodiments, not all the embodiments. Based on the embodiments of the present disclosure, it is understandable to a person skilled in the art, any other embodiments obtained by persons skilled in the art without creative effort shall all fall into the scope of the present disclosure.

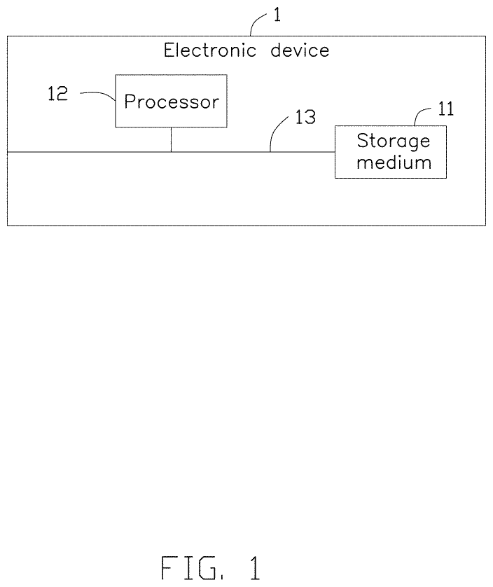

FIG. 1 shows an electronic device 1. The electronic device 1 includes a storage medium 11 and at least one processor 12, not being limited. The storage 11 and the at least one processor 12 communicate with each other through a communication bus 13 or directly communicate with each other.

The electronic device 1 can be a device with application programs, such as a computer, a mobile phone, a tablet, a personal digital assistant (PDA), and the like. The structure of the electronic device 1 as shown in FIG. 1 does not constitute a limitation on the electronic device 1, and the electronic device 1 may include more or fewer parts than that shown in the figure, or combine some parts, or have different arrangement of the parts. For example, the electronic device 1 also can include input output device, network device, and bus, and the like.

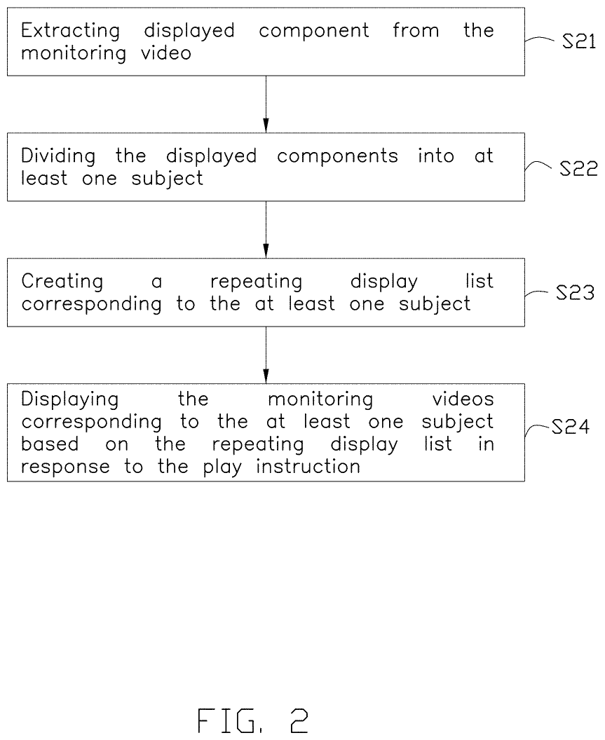

FIG. 2 shows a flowchart of a method for improving manner of display of surveillance videos used in the electronic device 1. Due to different requirements, a sequence of steps in the flowchart diagram can be changed, and some steps can be omitted. The method includes the following steps, these steps may be re-ordered:

In block S21, displayed components are extracted from the monitoring video.

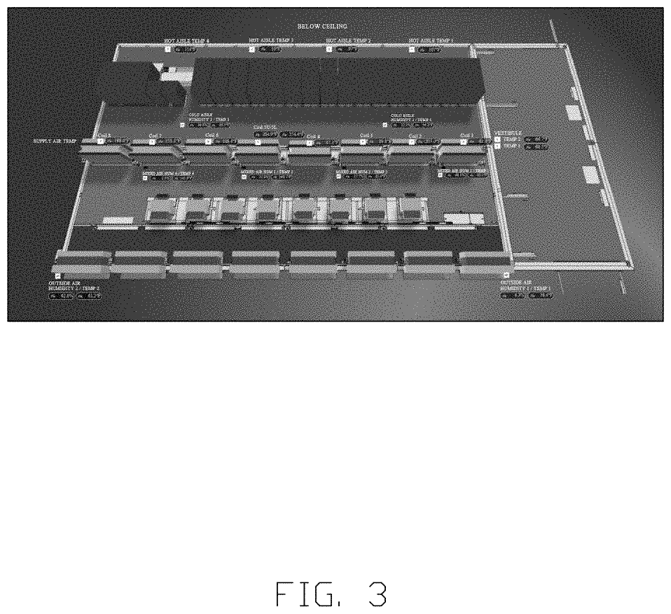

In one monitoring region, there are different types of components being monitored, such as states of air conditioning in a production workshop. For monitoring functions of each component or type of component, a graphical control tool is provided for visualizing the monitored data. For example, the monitored data are visualized as shown in FIG. 3. While visualizing the monitored data, the number of the components to be displayed is large, thus a target component is mixed up with other components, which is hard to view quickly and clearly by users.

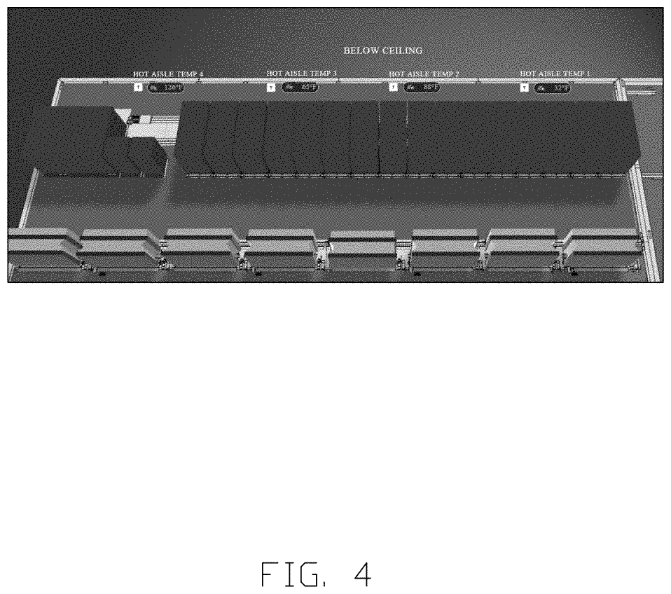

In one embodiment, each displayed component has its own related data in real time. As shown in FIG. 4, each frame with a current temperature label is one displayed component.

In one embodiment, the step of extracting a displayed component from the monitoring video includes obtaining the monitoring video of an image-capturing device. The displayed components are extracted from the monitoring video. For example, channel temperature displayed components, channel humidity displayed components, and fan state displayed components related to air conditioning can be extracted from the monitoring video in real time.

In block S22, the displayed components are divided into at least one subject.

In the monitoring region, there are different types of displayed components, which are hard to manage. In the block S22, the displayed components in a same type form a specified group. For example, the channel temperature displayed components form a channel temperature group, the channel humidity displayed components form a channel humidity group. Different groups under a same subject form a specified subject. For example, the channel temperature group and the channel humidity group form a channel environment subject.

In one embodiment, the step of dividing displayed components into at least one subject include:

Step (1): the displayed components are divided based on types of the displayed components to form at least one group. In one embodiment, the type of each displayed component is determined. The displayed components in a same type are divided into the same specified group.

Step (2): the at least one group is divided based on group types to form at least one subject. In one embodiment, a major function of each group is determined. For example, the major function of the channel temperature group is related to a channel environment. The groups in a same major function are divided into the same specified subject. The major function can be adjusted by different requirements, not being limited.

By dividing the displayed components into at least one subject, the displayed components can be easily managed.

In block S23, a repeating display list with the at least subject is created corresponding to the at least one subject.

In one embodiment, after the displayed components are divided into the at least one subject, the repeating display list with the at least subject is created for displaying different subjects in turn, thus the monitored data is clearly shown to the user.

For example, since the displayed components are related to the air conditioning, there is an air conditioning channel environment subject with a cold channel temperature group, a heat channel temperature group, a cold channel humidity group, and a heat channel humidity group used for viewing air environment of the air conditioning. A group showing rotation speed of a fan moving the air in an air conditioning is also provided for viewing state of the fan. An air conditioning compressor subject with a compressor group and a compressor humidity group are provided for viewing a data of the air conditioning compressor. In the repeating display list, the air conditioning channel environment subject, the air conditioning fan force subject, and the air conditioning compressor subject are displayed in that order. The monitoring videos related to the air conditioning channel environment subject are firstly displayed, the monitoring videos related to the air conditioning fan force subject are secondly displayed, and the monitoring videos related to the air conditioning compressor subject are thirdly displayed.

Based on the repeating display list related to the at least one subject, the manner of display of the monitoring videos is more convenient for the user in checking required details.

In a preferable embodiment, the method can further include a display interface of the monitored data being provided. The display interface includes a managing layer of the repeating display list on the right side. A selected subject in a specified subject database can be extracted and added into the managing layer of the repeating display list in response to a subject adding instruction. The selected groups in a specified group database are extracted and added into one subject in a subject list displayed in the display interface in response to a group adding instruction. The displayed components under the groups are displayed in a displayed component list. The selected displayed components in a specified displayed component database are extracted and added into the displayed component list in response to a displayed component adding instruction. The selected displayed components in the displayed component list can be removed in response to a removing instruction.

The method further includes:

A first monitor region in the monitoring video corresponding to each subject are obtained.

In one embodiment, the step of obtaining the first monitor regions in the monitoring video corresponding to each subject includes:

Step (a): at least one second monitor region corresponding to the displayed component in each subject is obtained. In detail, the region in which the displayed component is disposed serves as the second monitor region.

Step (b): coordinates of at least one second vertex in the at least one second monitor region are obtained. A point on an upper left corner of the monitoring video disposed in a forward direction serves as an origin O, a horizontal direction serves as an X axis, and a vertical direction serves as a Y axis, and a XOY coordinate system is formed. The coordinates of the four vertexes in the XOY coordinate system are obtained, which serve as the coordinates of the second vertexes.

Step (c): coordinates of first vertexes in the first monitor region are obtained based on the coordinates of the at least one second vertexes. In detail, the coordinates of the second vertexes in an upper left corner and in a bottom right corner in the second monitor region are obtained. A minimum coordinate in the extracted coordinates of the second vertexes in the upper left corner along the X axis serves as a coordinate of the first vertex in the upper left corner along the X axis, and a minimum coordinate in the extracted coordinates of the second vertexes in the upper left corner along the Y axis serves as a coordinate of the first vertex in the upper left corner along the Y axis. A maximum coordinate in the extracted coordinates of the second vertexes in the bottom right corner along the X axis serves as a coordinate of the first vertex in the bottom right corner along the X axis, and a maximum coordinate in the extracted coordinates of the second vertexes in the bottom right corner along the Y axis serves as a coordinate of the first vertex in the bottom right corner along the Y axis.

Step (d): a region defined by the first vertexes serves as the first monitor region. Each project corresponds to one first monitor region.

In block S24, the monitoring videos corresponding to the at least one subject is displayed based on the repeating display list in response to a play instruction.

When the user wants to view the monitoring video corresponding subject, the play instruction is generated on the display interface of the monitored data.

In one embodiment, the step of displaying monitoring videos corresponding to the at least one subject according to the repeating display list in response to the play instruction includes setting a display time duration. The display time can be adjusted according to user's requirement. A viewing angle of a monitor device is adjusted to face the first monitor region corresponding to the at least one subject based on the repeating display list. The monitoring videos corresponding to the first monitor region are displayed for the display time duration.

In detail, when the monitoring videos corresponding to the first monitor region corresponding to a subject being firstly displayed are displayed for the display time duration, then the viewing angle of the monitor device is adjusted to face the first monitor region corresponding to the next subject, and the monitoring videos of the first monitor region corresponding to the next subject are displayed for the display time duration. Then, the viewing angle of the monitor device is adjusted to face the first monitor region corresponding to the next subject, and the monitoring videos of the first monitor region corresponding to the next subject are displayed for the display time duration. For example, the display time duration is 30 seconds, the viewing angle of the monitor device is facing the first monitor region corresponding to the air conditioning channel environment subject, and the monitoring videos of the first monitor region corresponding to the air conditioning channel environment subject are displayed for 30 seconds. Then, the viewing angle of the monitor device is adjusted to face the first region corresponding to the air conditioning fan state subject for 30 seconds. Then, the viewing angle of the monitor device is adjusted to face the first region corresponding to the air conditioning compressor environment subject, and the monitoring videos of the first region corresponding to the air conditioning compressor environment subject are displayed for 30 seconds.

The monitoring videos corresponding to different subjects are displayed in turn by adjusting the viewing angle of the monitor device, the manner of display of the displayed components is simpler, and the monitoring videos are displayed more clearly, which is more convenient to the users for monitoring.

Referring to FIG. 1, in one embodiment, the storage medium 11 is an internal storage of the electronic device 1, which is embedded in the electronic device 1. In other embodiments, the storage medium 11 can be an external storage medium 11, which is coupled to the electronic device 1.

In some embodiments, the storage medium 11 stores program codes and various data. The storage medium 11 allows automatic access of the program or data during operations on the electronic device 1.

The storage medium 11 can be a random-access storage medium, or a non-volatile storage, such as a hard disk, a memory, a plug-in hard disk, a smart media card (SMC), a secure digital (SD), a flash card, a disk storage component, a flash component, or other volatile solid memory.

In one embodiment, the processor 12 can be a central processing unit (CPU), or other universal processor, such as a digital signal process (DSP), an application specific integrated circuit (ASIC), a field-programmable gate array (FPGA), or other programmable logic component, discrete gate or transistor logic, discrete hardware components, and so on. The universal processor can be a microprocessor or the at least one processor can be any regular processor, or the like.

If the modules/units of the storage medium 11 are implemented in the form of or by means of a software functional unit installed in independent or standalone product, all parts of the integrated modules/units of the storage unit may be stored in a computer-readable storage medium. One or more programs are used to control the related hardware to accomplish all or parts of the methods of this disclosure. The one or more programs can be stored in a computer-readable storage medium. The one or more programs can accomplish the step of the exemplary method when executed by the at least one processor 12. The program codes can be in the form of source code, object code, executable code file, or in some intermediate form. The computer-readable storage medium may include any entity or device capable of carrying the program codes, recording media, USB flash disk, mobile hard disk, disk, computer-readable storage medium, read-only memory, and the like.

Division of the modules is only a logical function division, and other division manners may be adopted during practical implementation. Each function module in each embodiment of the present disclosure may be integrated into a processing module, each module may also exist independently and physically, and two or more than two modules may also be integrated into a module. The above-mentioned integrated module may be implemented in a form of hardware and may also be implemented in forms of hardware and software function module.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for improving display manner of monitoring videos, applicable in an electronic device; the electronic device comprises a non-transitory storage medium with program codes and a processor; the processor executes the program codes in the non-transitory storage medium to implement the method; the method comprises:
extracting displayed component from the monitoring video;
dividing the displayed components into at least one subject;
creating a repeating display list corresponding to the at least one subject; and
displaying the monitoring videos corresponding to the at least one subject based on the repeating display list in response to a play instruction.

2. The method of claim 1, wherein the step of dividing the displayed components into at least one subject comprises:
dividing the displayed components based on types of the displayed components to form at least one group; and
dividing the at least one group based on group types to form the at least one subject.

3. The method of claim 1, wherein the step of creating a repeating display list based on the at least subject comprises:
obtaining a first monitor region in the monitoring video corresponding to each subject.

4. The method of claim 3, wherein the step of obtaining a first monitor region in the monitoring video corresponding to each subject comprises:
obtaining at least one second monitor region corresponding to the displayed component in each subject;
obtaining coordinates of at least one second vertex in the at least one second monitor region;
obtaining coordinates of first vertexes in the first monitor region based on the coordinates of the at least one second vertexes; and
defining a region by the first vertexes as the first monitor region.

5. The method of claim 4, wherein the step of obtaining coordinates of first vertexes in the first monitor region based on the coordinates of the at least one second vertexes comprises:
obtaining the coordinates of the second vertexes in an upper left corner and in a bottom right corner of the second monitor region;
serving a minimum coordinate in the extracted coordinates of the second vertexes in the upper left corner along an X axis as a coordinate of the first vertex in the upper left corner vertex along the X axis, and a minimum coordinate in the extracted coordinates of the second vertexes in the upper left corner along a Y axis as a coordinate of the first vertex in the first upper left corner along the Y axis;
serving a maximum coordinate in the extracted coordinates of the second vertexes in the upper left corner along the X axis as a coordinate of the first vertex in the bottom right corner vertex along the X axis, and a maximum coordinate in the extracted coordinates of the second vertexes in the bottom right corner along the Y axis as a coordinate of the first vertex in the first bottom right corner along the Y axis; and
serving the coordinate of the first vertex in the first upper left corner and the coordinate of the first vertex in the first bottom right corner as the coordinates of the first vertex.

6. The method of claim 1, wherein the method further comprises:
displaying a display interface with a managing layer of the repeating display list;
extracting and adding selected subjects in a specified subject database into the repeating display list in response to a subject adding instruction; and
extracting and adding selected groups in a specified group database into one subject in a subject list in response to a group adding instruction.

7. The method of claim 6, wherein the method further comprises:
displaying a displayed component list under one group;
extracting and adding selected displayed components in a specified displayed component database into the group in response to a displayed component adding instruction; and
removing the selected displayed components in response to a removing instruction.

8. The method of claim 3, wherein the method further comprises:
setting a display time duration;
adjusting a viewing angle of a monitor device to face the first monitor region corresponding to the at least one subject based on the repeating display list;
displaying the monitoring videos corresponding to the first monitor region for the display time duration.

9. An electronic device comprises a non-transitory storage medium with program codes, which when being executed by a processor, cause the processor to:
extract displayed component from the monitoring video;
divide the displayed components into at least one subject;
create a repeating display list corresponding to the at least one subject; and
display the monitoring videos corresponding to the at least one subject based on the repeating display list in response to a play instruction.

10. The electronic device of claim 9, wherein, the processor further:
obtain a first monitor region in the monitoring video corresponding to each subject.

11. The electronic device of claim 10, wherein the processor further:
obtain at least one second monitor region corresponding to the displayed component in each subject;
obtain coordinates of at least one second vertex in the at least one second monitor region;
obtain coordinates of first vertexes in the first monitor region based on the coordinates of the at least one second vertexes; and
define a region by the first vertexes as the first monitor region.

12. The electronic device of claim 11, wherein the processor further:
obtain the coordinates of the second vertexes in an upper left corner and in a bottom right corner of the second monitor region;
serve a minimum coordinate in the extracted coordinates of the second vertexes in the upper left corner along an X axis as a coordinate of the first vertex in the upper left corner vertex along the X axis, and a minimum coordinate in the extracted coordinates of the second vertexes in the upper left corner along a Y axis as a coordinate of the first vertex in the first upper left corner along the Y axis;
serve a maximum coordinate in the extracted coordinates of the second vertexes in the upper left corner along the X axis as a coordinate of the first vertex in the bottom right corner vertex along the X axis, and a maximum coordinate in the extracted coordinates of the second vertexes in the bottom right corner along the Y axis as a coordinate of the first vertex in the first bottom right corner along the Y axis; and
serve the coordinate of the first vertex in the first upper left corner and the coordinate of the first vertex in the first bottom right corner as the coordinates of the first vertex.

13. The electronic device of claim 10, wherein the processor further:
set a display time duration;
adjust a viewing angle of a monitor device to face the first monitor region corresponding to the at least one subject based on the repeating display list;
display the monitoring videos corresponding to the first monitor region for the display time duration.

14. The electronic device of claim 9, wherein the processor further:
display a display interface with a managing layer of the repeating display list;
extract and add selected subjects in a specified subject database into the repeating display list in response to a subject adding instruction; and
extract and add selected groups in a specified group database into one subject in a subject list in response to a group adding instruction.

15. The electronic device of claim 14, wherein the processor further:
display a displayed component list under one group;
extract and add selected displayed components in a specified displayed component database into the group in response to a displayed component adding instruction; and
remove the selected displayed components in response to a removing instruction.

16. A computer readable storage medium stores program codes; the program codes are executed by at least one processor to implement the following steps:
extracting displayed component from the monitoring video;
dividing the displayed components into at least one subject;
creating a repeating display list corresponding to the at least one subject; and
displaying the monitoring videos corresponding to the at least one subject based on the repeating display list in response to a play instruction.

17. The computer readable storage medium of claim 16, wherein the step of creating a repeating display list based on the at least subject comprises:
obtaining a first monitor region in the monitoring video corresponding to each subject.

18. The computer readable storage medium of claim 17, wherein the step of obtaining a first monitor region in the monitoring video corresponding to each subject comprises:
obtaining at least one second monitor region corresponding to the displayed component in each subject;
obtaining coordinates of at least one second vertex in the at least one second monitor region;
obtaining coordinates of first vertexes in the first monitor region based on the coordinates of the at least one second vertexes; and
defining a region by the first vertexes as the first monitor region.

19. The computer readable storage medium of claim 18, wherein the step of obtaining coordinates of first vertexes in the first monitor region based on the coordinates of the at least one second vertexes comprises:
obtaining the coordinates of the second vertexes in an upper left corner and in a bottom right corner of the second monitor region;
serving a minimum coordinate in the extracted coordinates of the second vertexes in the upper left corner along an X axis as a coordinate of the first vertex in the upper left corner vertex along the X axis, and a minimum coordinate in the extracted coordinates of the second vertexes in the upper left corner along a Y axis as a coordinate of the first vertex in the first upper left corner along the Y axis;
serving a maximum coordinate in the extracted coordinates of the second vertexes in the upper left corner along the X axis as a coordinate of the first vertex in the bottom right corner vertex along the X axis, and a maximum coordinate in the extracted coordinates of the second vertexes in the bottom right corner along the Y axis as a coordinate of the first vertex in the first bottom right corner along the Y axis; and
serving the coordinate of the first vertex in the first upper left corner and the coordinate of the first vertex in the first bottom right corner as the coordinates of the first vertex.

20. The computer readable storage medium of claim 16, wherein the step of obtaining a first monitor region in the monitoring video corresponding to each subject comprises:
setting a display time duration;
adjusting a viewing angle of a monitor device to face the first monitor region corresponding to the at least one subject based on the repeating display list;
displaying the monitoring videos corresponding to the first monitor region for the display time duration.
